(19) United States
(12) Patent Application Publication
(10) Pub. No.: US 2017/0222207 A1
(43) Pub. Date: Aug. 3, 2017

(54) Battery Cell Connector, Interconnect Board And Battery Block System

(71) Applicant: Boston-Power, Inc., Westborough, MA (US)

(72) Inventors: Jamison M. Pezdek, Boston, MA (US); W. Dale Robertson, Charlton, MA (US); Rui E. Frias, East Freetown, MA (US); Ken Sghia-Hughes, Acton, MA (US)

(21) Appl. No.: 15/014,411

(22) Filed: Feb. 3, 2016

(51) Int. Cl. H01M 2/20; H01M 2/10

(52) U.S. Cl. CPC H01M 2/202; H01M 2/1011

(57) ABSTRACT

A battery cell connector for a battery module includes a set of arms linked to a base portion. An interconnect board for connecting a plurality of battery cells includes a circuit board and a plurality of the battery cell connectors. A battery module system includes a battery block that has a tray and a plurality of battery cells, and the interconnect board in mating relationships with the tray. A battery system includes first and second trays that support a first and second pluralities of battery cells, and the interconnect board having a plurality of the battery cell connectors linking the first and second pluralities of battery cells.

### BACKGROUND OF THE INVENTION

Many devices, including computers and electric vehicles, are powered by secondary (rechargeable) batteries, such as lithium-ion, nickel cadmium, nickel-metal hydride and lead acid batteries. Many of these devices consume enough electricity to require that conventional secondary batteries be connected collectively in modular form, such as in battery modules of six, eight, or up to several dozen batteries per module. Devices may operate at voltages requiring series connections of cells to achieve this voltage. Parallel connections of cells increase the total energy capacity available. However, secondary batteries, such as the lithium-ion secondary batteries, typically can vary from cell-to-cell and, therefore, must be monitored (for safety, life, discharge and charge limits) during charging and discharging. When necessary, they must be charged separately or selectively discharged in order to balance the cells in each battery module and thereby maximize the collective efficiency and utilization of the individual cells.

Further, some cells have shorter cycle lives than others within a single battery module, and it can be difficult to selectively access and replace individual modules, thereby deleteriously affecting the performance of the battery system and the device as a whole. This, in addition to an inability of many battery systems to identify individual cells failing within a module, often requires that the module be replaced, thereby adding to the expense of maintenance associated with the battery system, and reducing the efficiency and utility of the device relying upon the battery system.

Battery cell connectors typically require assembly during attachment to a circuit board. Further, known connectors often require a permanent, or semi-permanent mechanical connection, such as solder, weldment, bonding, or permanent mechanical fastening. Also, battery cell connectors generally are fabricated from component parts, which often result in electrical resistances at interfaces between conductors, and which can cause the connectors to fail.

Therefore, a need exists for a battery solution that overcomes or minimizes the above-referenced problems.

### SUMMARY OF THE INVENTION

The invention generally is directed to a battery cell connector, an interconnect board for connecting a plurality of battery cells, and a battery module system.

In one embodiment, the invention is a battery cell connector that includes a base and a plurality of arms. The plurality of arms extend radially from the base and define distal ends, the base and the arms collectively defining a concave surface and a convex surface opposite the concave surface. In one embodiment, a spring is fixed to the base and extends along the convex surface of the arms, whereby application of force to the concave surface of the arms causes the spring to exhibit a spring constant.

In another embodiment, the invention is an interconnect board for connecting a plurality of battery cells. The interconnect board includes a circuit board, a plurality of battery cell connectors, and an electrically-conductive link between pairs of the battery cell connectors. The interconnect board includes at least one electrically-conductive channel. The plurality of battery cell connectors are located at the circuit board, at least a portion of which are in electrical communication with each other through the electrically conductive channel. At least one of the battery cell connectors includes: i) a base; and ii) a plurality of arms extending radially from the base and defining distal ends, the base and the arms collectively defining a concave surface and a convex surface opposite the concave surface. In one embodiment, at least a portion of the battery connectors include a spring fixed to the base and extending along the convex surface of the arms, whereby application of force to the concave side of the arms causes the spring to exhibit a spring constant. The plurality of rivets each extend through the apertures and provide electrical communication between pairs of the battery cell connectors across the circuit board, the convex surface of each battery cell connector facing the circuit board.

In still another embodiment, the invention is a battery module system that includes a first tray, a second tray, and an interconnect board. The first tray supports a first plurality of battery cells of a first battery block where the first plurality of battery cells is assembled within the first tray, wherein first terminals of the first plurality of battery cells are aligned in a first plane at a first end of the first battery block and second terminals of each of the first plurality of battery cells are aligned in a second plane at a second end of the first battery block. The second tray supports a second plurality of battery cells of a second battery block where the second plurality of battery cells is assembled within the second tray, wherein first terminals of the second plurality of battery cells are aligned in the first plane at a first end of the second battery block and second terminals of each of the second plurality of battery cells are aligned in the second plane at a second end of the second battery block. The interconnect board is in mating relationship with the first tray and the second tray, and includes a circuit board and a plurality of battery cell connectors, at least a portion of which are in electrical communication with each other through the interconnect board, wherein at least one of the battery cell connectors includes a base defining an aperture and a plurality of arms extending radially from the base and defining distal ends, the base and the arms collectively defining a concave surface and a convex surface opposite the concave surface. An electrically-conductive link extends between the pairs of the battery connectors through the circuit board, whereby the first and second battery blocks, respectively, are in contact with at least a portion of the arms of the pairs of the battery cell connectors, the first and the second battery cell blocks thereby being in series electrical connection with each other. In one embodiment, at least a portion of the battery cell connectors includes a spring fixed to the base and extending along the convex surface of the arms, whereby application of force to the concave surface of the arms causes the spring to exhibit a spring constant.

The battery cell connector of the invention can include a base and arms formed of a single, continuous electrically-conductive material. The base and arms can also have a substantially uniform cross-sectional area. In a further embodiment, at least one of the arms can include a fusible link, and the fusible link can have a cross-sectional area less than a cross-sectional area of the remainder of the arm. Each of the arms can also include a protrusion at the distal end of the on the concave side, the protrusion facilitating electrical communication with a terminal of a battery cell. The base can also include features that can enable mounting the connector (e.g., to a printed circuit board (PCB)), including an aperture defined by the base and a tab extending from the base. The aperture can accommodate a rivet extending through the aperture whereby the rivet functions as an electrically conductive link between the bases of each pair of battery cell connectors on opposite sides of a printed circuit board.

The battery cell connector of the invention can also be configured such that the arms extends radially from the base in a direction opposite that of another of the arms. The arms can extend radially from the base in a direction having an angle of about 90 degrees with respect to another of the arms. The arms and the base can be formed of a suitable material, such as copper, aluminum, or any other electrical conductor, while the spring can be formed of a suitable material such as steel. Each of the arms can include a contact pad at a distal end of the arm on the concave side, and the contact pad can be formed of a suitable material, such as a nickel-silver alloy. In one embodiment, the arms each include a protrusion at or proximate to a distal end of the arm, whereby the protrusions of arms extending from a single base all lie in a virtual place.

The invention provides many advantages. For example, the battery cell connector of the invention can be conveniently attached to a circuit board via a rivet or other mechanical methods, and without requiring assembly of the connector during attachment to the circuit board. In addition, the arms of the battery cell connector can provide electrical contact between the battery cells without requiring a permanent or semi-permanent mechanical connection, such as solder, weldment, bonding, or permanent mechanical fastening, thereby enabling the battery cells be easily assembled and separated. Further, the conductive portion of the battery cell connectors of the invention can be fabricated easily from a single, continuous piece of metal, thereby eliminating the electrical resistance inherent in the interfaces between conductors. This feature also improves the reliability of the connection. A further feature improving reliability of the connection is the compliant nature of the design, which results in the connection being unaffected by vibrations and shock on the contact. Where, in contrast, stress on welded connections can cause fractures in the welds, the invention can move in the X, Y, and Z directions while allowing the contact to maintain an intimate interface.

The interconnect board of the invention can include a circuit board of at least one electrically-conductive channel that enables features including cell balancing and monitoring of battery cells connected to the circuit board. The monitoring of battery cells can include, for example, the state of charge and temperature of the individual battery cells. Individual monitoring of cells in a plurality of battery cells, such as the plurality of cells of a battery module, enables identification of individual cells that require replacement while the battery module is in operation, and without requiring removal of the entire battery module and individual testing of battery cells of the module.

The battery module system of the invention can include a battery block that includes a tray and a plurality of battery cells, and an interconnect board in mating relationship with the tray. The tray, with the batteries, are easily separated from the interconnect board as a unit, and easily substituted or reassembled to form a new battery module system, as necessary. In addition, the battery block of the invention, like the battery module system of the invention, can be easily assembled and disassembled, and can be stacked to form a module system that employs several stacked trays of battery cells, all connected through interconnect boards between each tray, thereby enabling the formation of a battery system with any number of trays of battery cells, and which can be disassembled, as necessary, to remove and replace individual trays of battery cells or, even, individual cells within battery trays, said individual cells having been monitored through the interconnect board of the battery system.

### BRIEF DESCRIPTION OF THE DRAWINGS

FIG. 1A is a plan view of one embodiment of a battery cell connector of the invention.

FIG. 1B is a side view of the battery cell connector of FIG. 1A.

FIG. 1C is a perspective view of the battery cell connector of FIG. 1A.

FIG. 1D is a side view of the battery cell connector of FIG. 1A undergoing a force at the respective arms.

FIG. 2 is a side view, shown in part, of a cell interconnect of the invention connecting several battery cells in series.

FIG. 3A is a plan view of one embodiment of a battery cell connector of the invention including a fusible link.

FIG. 3B is a side view of the battery cell connector of FIG. 3A.

FIG. 3C is a perspective view of the battery cell connector of FIG. 3A.

FIG. 4A is a plan view of an interconnect board of the invention for connecting a plurality of battery cells, including a circuit board.

FIG. 4B is a side view of the interconnect board of FIG. 4A.

FIG. 4C is a perspective view of the interconnect board of FIG. 4A.

FIG. 5 is a plan view of the circuit board of FIG. 4A.

FIG. 6 is a schematic representation of a voltage detection component of the circuit board of FIG. 4A.

FIG. 7 is a perspective view of one embodiment of a battery module system of the invention, including two battery blocks coupled via an interconnect board.

FIG. 8 is an exploded view of a further embodiment of a battery module system of the invention.

FIG. 9 is a schematic representation of two blocks of battery cells, each block including sixteen battery cells, such as can be employed in the battery module system of the invention.

FIG. 10 is a schematic representation of a battery system of the invention, wherein each battery block includes sixteen battery cells.

FIG. 11 is a perspective view of one embodiment of a battery cell connector of the invention that includes a spring.

FIG. 12 is a side view of the battery cell connector of FIG. 11, showing the battery cell connector in an unloaded position (A) and a loaded position (B).

FIG. 13 is a side view of two battery cell connectors of FIGS. 11 and 12, that are connected through a circuit board.

FIG. 14A is a plan view of a further embodiment of a battery cell connector of the invention.

FIG. 14B is a side view of the battery cell connector of FIG. 14A.

FIG. 14C is a perspective view of the battery cell connector of FIG. 14A.

FIG. 15A is a side view of a further embodiment of a battery cell connector of the invention.

FIG. 15B is a plan view of the battery cell connector of FIG. 15A.

FIG. 15C is a perspective view of the battery cell connector of FIG. 15A.

FIG. 16A is a plan view of a further embodiment of a battery cell connector of the invention.

FIG. 16B is a side view of the battery cell connector of FIG. 16A.

FIG. 16C is a further side view of the battery cell connector of FIG. 16A.

FIG. 16D is a perspective view of the battery cell connector of FIG. 16A

### DETAILED DESCRIPTION OF THE INVENTION

The teachings of all patents, published applications and references cited herein are incorporated by reference in their entirety. In particular, embodiments of the invention may incorporate features, and may be implemented in systems, described in U.S. patent application Ser. No. 14/095,149, granted as U.S. Pat. No. 9,184,431, the entire teachings of which are incorporated herein by reference.

The invention generally is directed to a battery cell connector, an interconnect board for connecting a plurality of cells, a battery module system and a battery pack for use with secondary (rechargeable) batteries, such as lithium ion, nickel cadmium, nickel-metal hydride and lead acid batteries. The various embodiments of the invention facilitate convenient assembly of multiple cells, blocks of cells, and battery modules into battery pack systems. The invention enables improved connection, packaging, monitoring, and servicing, including removal and replacement, of subunits of the battery pack systems, such as individual blocks or modules of the battery pack system.

As defined herein, a “battery block,” is a collection of cells together in a predetermined orientation.

Also, as defined herein, a “battery module” is the collection of battery blocks connected together in series and/or parallel and includes a positive and negative terminal.

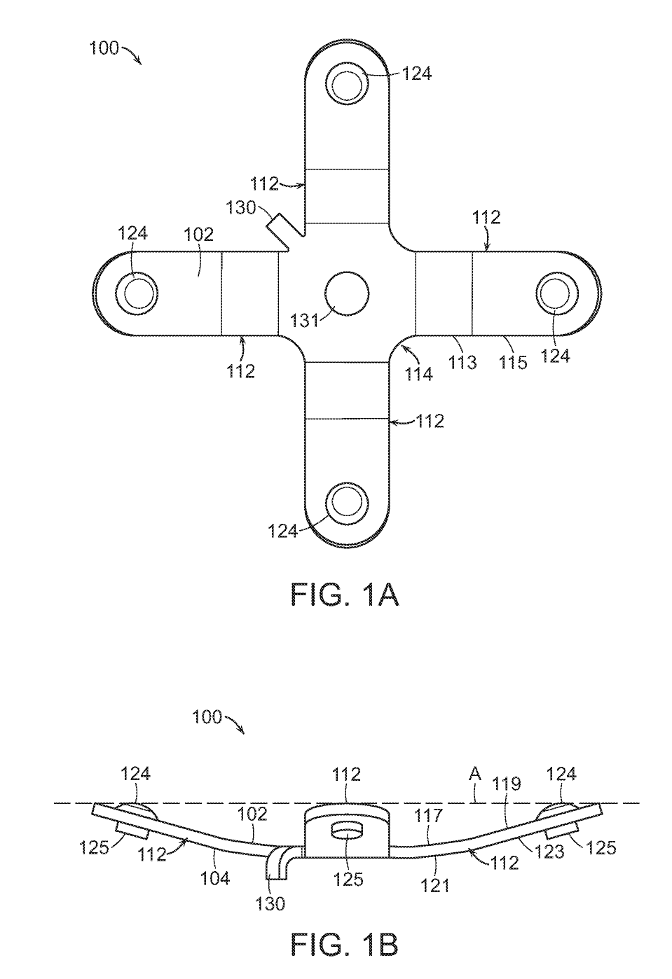

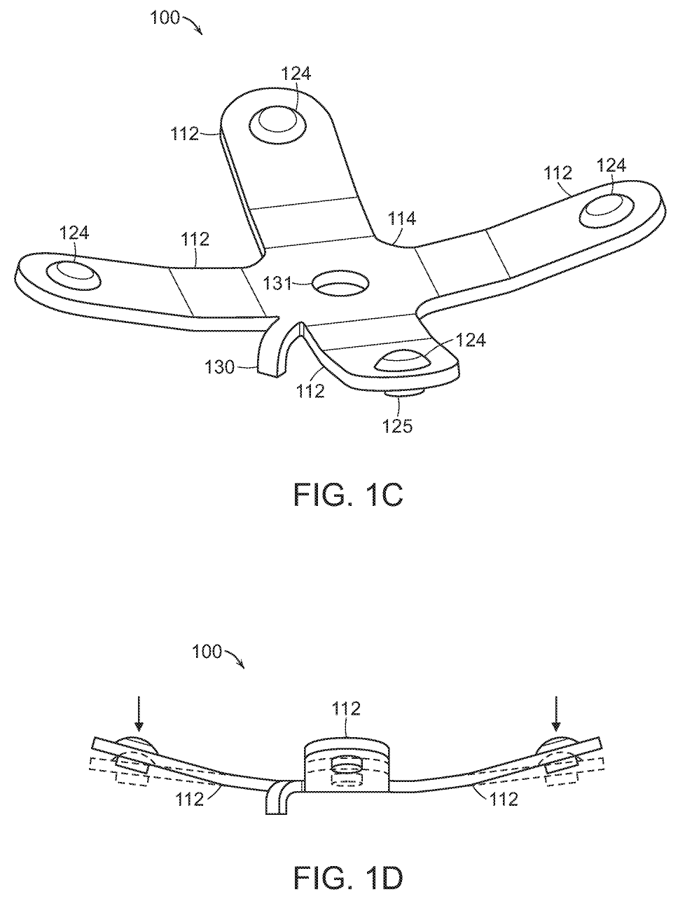

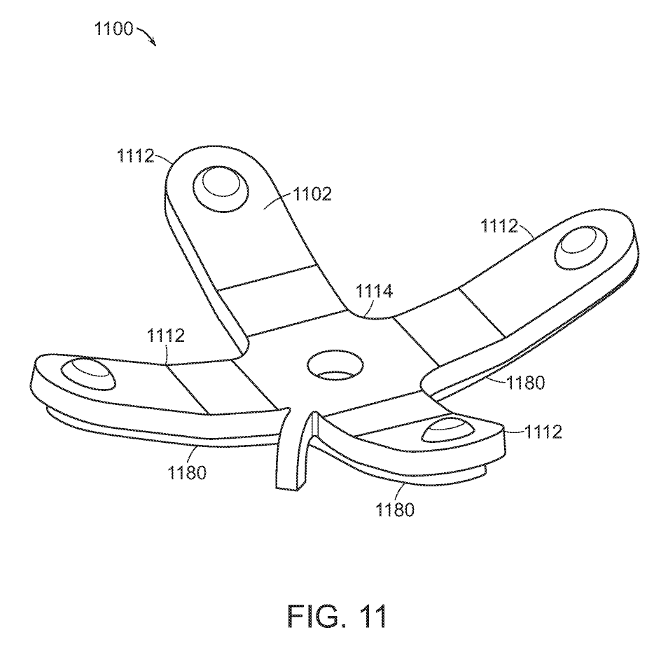

In one embodiment, the invention is a battery cell connector 100, shown in FIGS. 1A-1D. As shown therein, battery cell connecter 100 includes base 114 and four arms 112 having, in one embodiment, essentially constant cross-sectional areas along their lengths. As shown, each of arms 112 includes segments 113, 115. Segments 113, 115 are flat, and define essentially planar surfaces 117, 119, respectively, on concave surface 102, and essentially planar surfaces 121, 123, respectively, on convex surface 104. In an alternative embodiment, not shown, each of arms is a single segment defining essentially planar surfaces. The combination of arms and base of each battery cell connector in this embodiment defines a concave surface and a convex surface opposite the concave surface. Base 114 defines aperture 131. Arms 112 extend radially from base 114 and define distal ends. As can be seen in FIGS. 1B and 1C, base 114 and arms 112 collectively define concave surface 102 and convex surface 104, concave surface 104 and convex surface 104 being bridged by aperture 131. As defined herein, a “concave surface” and a convex surface” refers to any formation that approximates a concave or convex surface, respectively. For example, in alternative embodiments, arms 112 may include segments that each define essentially planar surfaces, but which, viewed collectively, approximate a concave or convex surface. Alternatively, the planar arms may define arcuate surfaces that at least approximate concave or convex surfaces. In still another embodiment, at least one of the arms may each include only a single segment, defining a planar surface, but wherein the combination of the arms and base of each battery cell connector defines a concave and convex surface. In one embodiment, arms 112 also function as springs, whereby application of force to the concave side of the arms causes arms 112 to exhibit a spring constant as shown in FIG. 1D. Optionally, or alternatively, battery cell connector 100 includes a spring fixed to base 114 and extending along convex surface 104 of arms 112, whereby application of force to concave surface 102 of arms 112 causes the spring to exhibit a spring constant. An example embodiment including such a spring is described in further detail below with reference to FIG. 11.

In one embodiment, base 114 also includes tab 130. Tab 130 extends radially from base 114 and downward through convex surface 104 of battery cell connector 100. Both aperture 131 and tab 130 can be employed to mount battery cell connector 100 to a circuit board or other device (not shown).

In one embodiment, arms 112 include protrusions 124 for contacting a terminal of a battery cell (not shown). In a specific embodiment, each protrusion 124 is a contact pad at an end of arm 112 distal to base portion 114. The contact pad has a surface that is raised from arm 112. Protrusions 124 are fixed to arm 112 or are integral to arm 112. In one embodiment, as shown in FIGS. 1B and 1C, protrusions 124 are fixed to arm 112 by rivet 125. In a further embodiment, protrusions 124 are fixed to arm 112, absent rivet 125, by another suitable method, such as by soldering. In one embodiment, protrusions 124 define virtual plane A.

In one embodiment, battery cell connector 100 is of a suitable single, continuous, electrically-conductive material. Examples of suitable materials of battery cell connecter 100 include aluminum, copper or a copper alloy. An example of a suitable copper alloy is a beryllium copper alloy. In one embodiment, the material of battery cell connecter 100 is sufficient to exert a force that provides a contact interface voltage below the contact material melting voltage. As defined herein, a “contact interface voltage below the contact material melting voltage,” means that the voltage drop across the contact is not sufficient enough to cause melting of the contact material. As described above, at least in one embodiment, as shown for example in FIG. 1D, battery cell connector 100 will exhibit a spring constant, whereby application of opposing external forces on opposing contact pads 124 of each pair of battery cell connector 100 sufficient to deform the shape of arms 112, will be opposed by a force of arms 112, and removal of that force will cause arms 112 to resume their original positions.

In one embodiment, battery cell connector 100 is plated with a suitable material. Examples of suitable plating materials include at least one member selected from the group consisting of silver, gold, tin, platinum and palladium. Alternatively, coining of alloys or mixtures such as silver-nickel onto the surface may be employed.

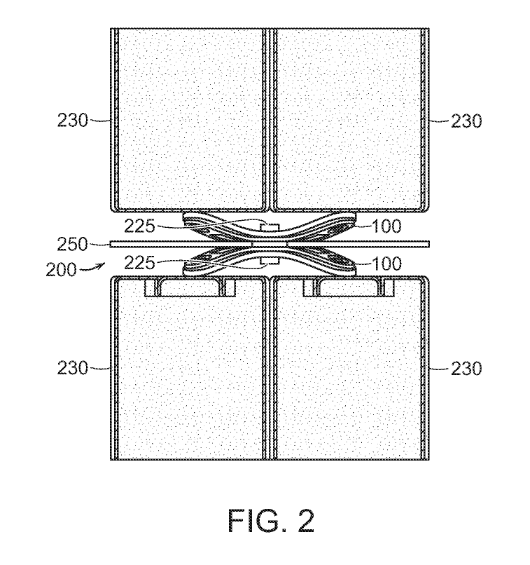

FIG. 2 is a side view, shown in part, of battery cell interconnect board 200 of the invention connecting several battery cells 230 in series. Interconnect board 200 includes circuit board 250 and pair of battery cell connectors 100 fixed to opposite sides of circuit board 250 via rivet 225. Battery cell connectors 100 extend outward from circuit board to contact terminals of batteries 230. Protrusions 124 at distal ends of arms 112 contact terminals of batteries 230, as can be seen in FIG. 2, thereby providing electrical contact between poles of two opposing batteries 230.

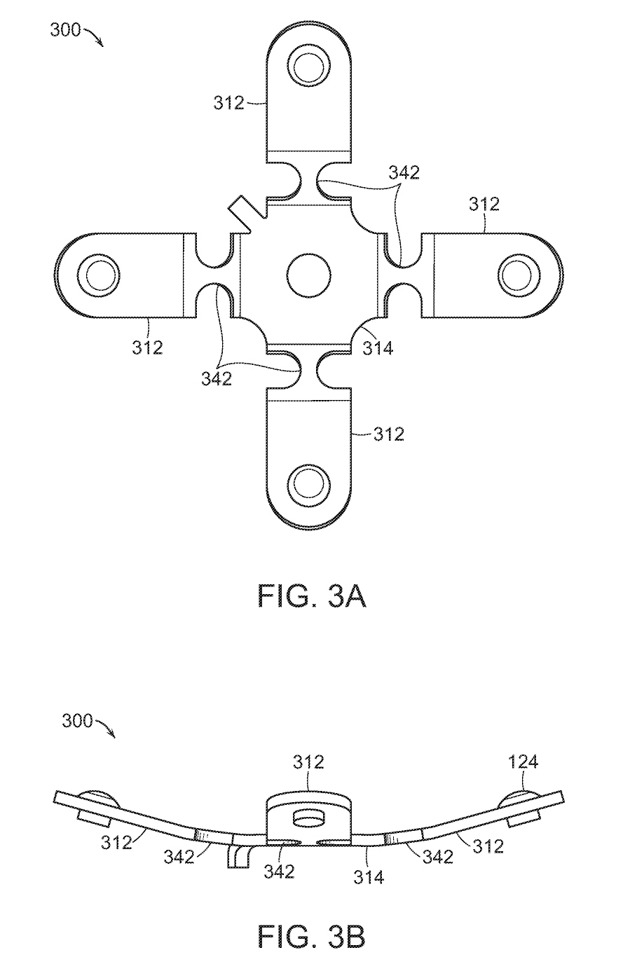

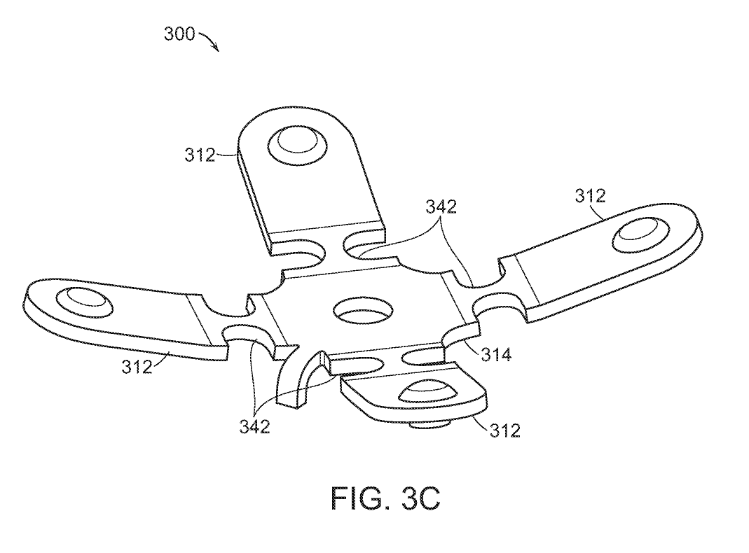

FIGS. 3A-C illustrate one embodiment of a battery cell connector 300 of the invention including fusible links. In contrast to battery cell connector 100 of FIGS. 1A-C, wherein arms 312 have an essentially uniform cross-sectional area, battery cell connector 300 includes fusible links 342. Fusible link 342 acts as the bridge linking arms 312 to base 314. Fusible links 342 are formed of a suitable material, such as aluminum, copper or a copper alloy. Fusible links 342 are designed to fail, thereby electrically separating arms 312 from base 314, when the current is sufficiently high to melt the contact material, thereby causing it to fail and create an open circuit. In one embodiment, battery cell connector 300 can conduct a current of at least about 10 amps before fusible links 342 cause such a failure. As shown in FIGS. 3A-C, fusible links 342 can have a cross-sectional area less than the cross-sectional area of the arms 312.

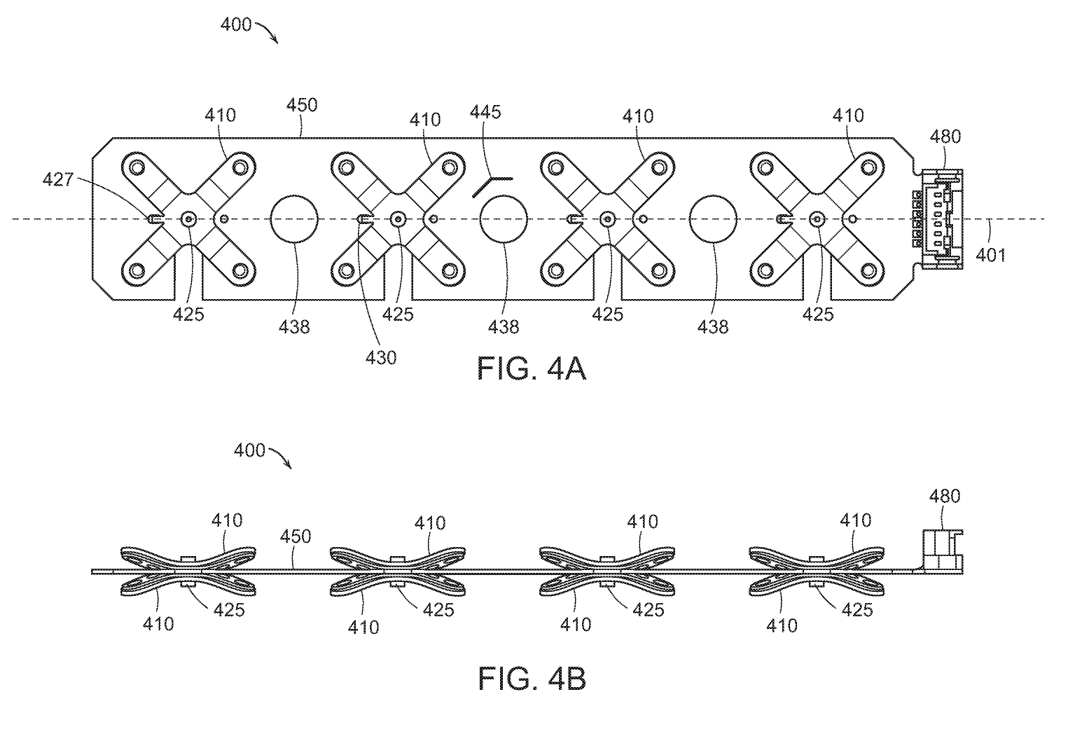

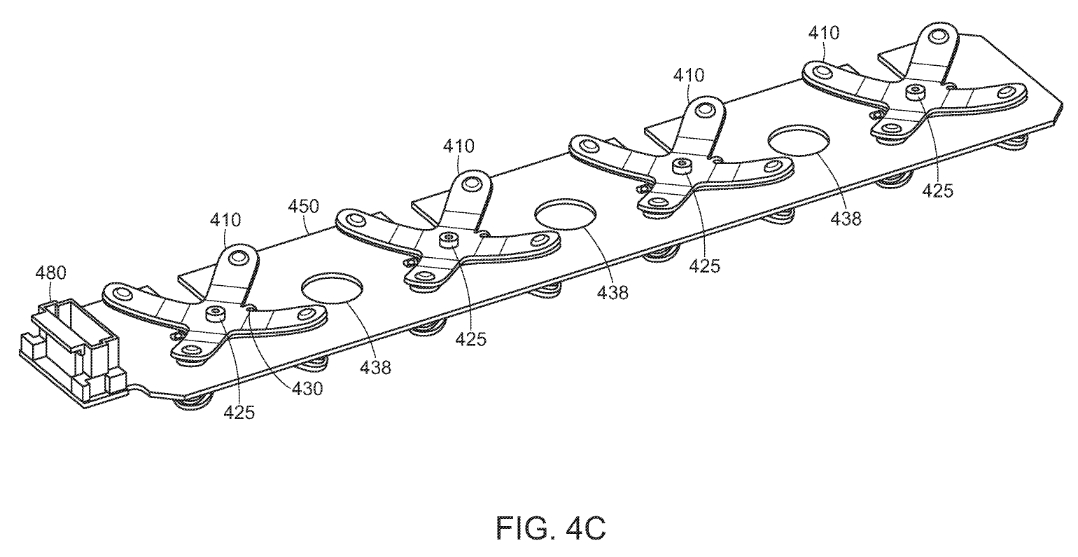

In another embodiment, shown in FIGS. 4A-4C, the invention is interconnect board 400 for connecting a plurality of battery cells. Interconnect board 410 includes circuit board 450 having at least one electrically-conductive channel 445 (shown in-part in FIG. 4A), and plurality of battery cell connectors 410 at circuit board 450. At least a portion of battery cell connectors 410 which are in electrical communication with each other through electrically-conductive channel 445. Circuit board 450 defines openings 430. Port 480, located at one end of circuit board 450 along longitudinal axis 401, houses terminals for connecting circuit board 450 to external circuitry, such as a battery management system (not shown).

Battery cell connectors 410 are fixed to circuit board 450 via rivets 425 extending through connectors 410 and circuit board 450. Rivets 425 can join two battery cell connectors 410 mounted to opposite sides of circuit board 450, thereby electrically joining two battery cell connectors 410 on opposite sides of circuit board 450. Battery cell connectors 410 can also be in electrical communication with each other via channel 445, as well as in electrical communication with port 480. Each battery cell connector 410 includes four terminals on a given side of circuit board 450 that are in electrical communication with each other. Tabs 430 connect each battery cell connector 410 to electrically-conductive channel 445. Examples of suitable battery cell connectors 410 are those shown in FIGS. 1A-1C and 3A-3C.

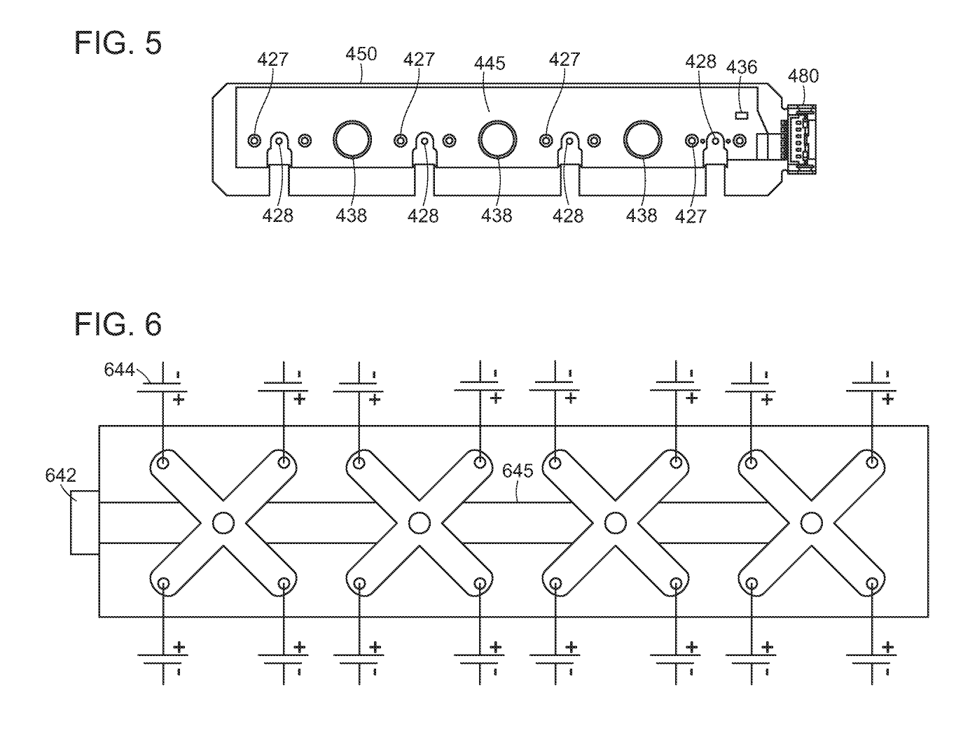

FIG. 5 illustrates circuit board 450 absent battery cell connectors. Electrically-conductive channel 445 of circuit board 450 connects at least a subset of plurality of battery connectors (shown in FIGS. 4A-C) mounted to circuit board 450 via mounting apertures 427 and 428, and may connect at least a subset of a plurality of battery connectors for one or more of cell balancing, temperature monitoring and voltage monitoring, as well as connection to one or more terminals of connection port 480. Electrically conductive channel 445 may also include at least one fusible link integrated into the etching of channel 445 between at least a subset of a plurality of battery connectors. In a particular embodiment, at least one fusible link electrically isolates at least one battery cell from other battery cells to which it is electrically connected. Fusible links will isolate the at least one battery cell from other battery cells in response to conduction of a current greater than a threshold current.

In one embodiment, electrically-conductive channel 445 includes or is electrically connected to a balancing circuit that balances battery cells connected with each other, such as battery cells connected in parallel with each other through battery cell connectors (e.g., connectors 410 of FIGS. 4A-C). Optionally, circuit board 450 includes a voltage circuit at, or in electrical communication with a circuit through terminals of port 480, wherein the circuit indicates voltage of at least a subset of the battery cells in electrical communication with each other. In one embodiment, the electrical circuit to which circuit board 450 is linked includes a voltage-monitoring circuit. Optionally, the circuit board 450 may include a parallel copper layer to balance battery cells connected to battery cell connector by electrically connecting battery cell connectors.

Optionally, temperature circuit (thermistor) 436 is located on, or is in electrical communication with circuit board 450, wherein the temperature circuit 436 indicates the temperature in proximity of at least one of the battery cells. One or more terminals of port 480 can be connected to temperature circuit 436 to provide temperature information to external devices in electrical communication with circuit board 450.

Circuit 600, represented in the circuit diagram of FIG. 6, shows the electrical network 645 between a voltage sense connector 642 and batteries 644 in electrical communication with battery cell connectors (not shown) at an interconnect board. Network 645 may also enable passive cell balancing and may connect to monitoring circuitry (not shown). Circuit 600 may represent the circuit formed by interconnect board 400 of FIGS. 4A-C and 5, wherein electrically conductive channel 445 of circuit board 450 forms an electrical network 645 between battery cell connectors 410 and at least one terminal of port 480 includes a voltage sense connector 642.

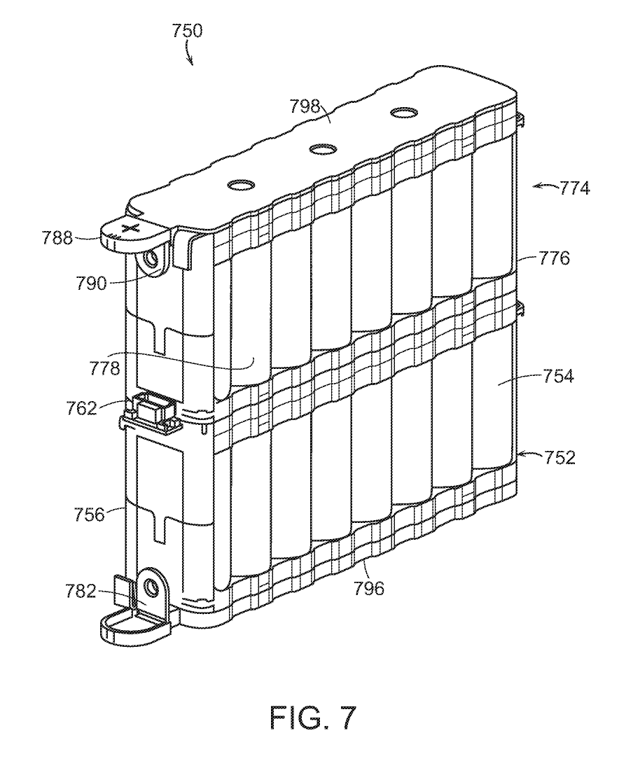

FIG. 7 illustrates one embodiment of a battery module system 700 of the invention, including two battery blocks 752 and 774 coupled via interconnect board 762. Battery module system 700 includes first tray 756, which supports a plurality of battery cells 754. The plurality of battery cells 754 are assembled within tray 756, wherein first terminals of battery cells 754 are aligned in a first plane at a first end of first battery block 752, and second terminals (not shown) at a second end of first battery block 752 of each of the plurality of battery cells 754 are aligned in a second plane. Second tray 776 supports battery cells 778 of second battery block 774 at interconnect board 762, wherein battery cells 754 of first battery block 752 are connected to battery cells 778 of secondary battery block 774 in series through battery cell connectors (not shown) at interconnect board 762. Interconnect board 762 can be, or include some or all of the features of interconnect board 400 described above with reference to FIGS. 4A-C and 5.

First end cap 796 is connected to first battery block 752 opposite interconnect board 762. First end cap 796 connects the plurality of cells of first battery block 752 in parallel at one end of the first and second terminals of battery cells. First end cap 796 can include battery cell connectors (not shown), such as battery cell connectors 410 of FIGS. 4A-C, in electrical communication with negative terminal 782 for electrically connecting the battery cells of the battery blocks interconnected by battery module system 700 to an external monitor or other system (not shown) powered by battery module system 700.

Second end cap 798 is connected to second battery block 774 supported by tray 776 and is positioned on the opposite side of interconnect board 762 from first end cap 796. Second end cap 798 connects the plurality of cells of second battery block 774 in parallel at one of the first and second terminals of the batteries of second battery block 774. Second end cap 798 can include battery cell connectors (not shown), such as battery cell connectors 410 of FIGS. 4A-C, in electrical communication with positive terminal 788 for connection to an external system, such as a motor or other system (not shown) powered by battery module system 700. Positive terminal 788 includes tab 790 for monitoring voltage of batteries of the second battery block in cooperation with interconnect board 762.

Battery module system 700 may be adapted to accommodate a plurality of battery cells 754 having one or more different cell types. For example, a plurality of battery cells 754 may include standard 18650-type battery cells. In order to accommodate battery cells of different types, battery module system 700 may be modified to accommodate such battery cells, for example by modifying the dimensions of trays 756, 776, interconnect board 762 and end caps 796, 798 in order to properly house and connect to the terminals of a given battery cell type.

Optionally, battery module system 750 can be held together by threaded screws, which are threaded to stringers (not shown) that extend through openings of end caps 796, 798, trays 756, 776 and interconnect boards 762. The battery module system of the invention, can include trays supporting battery blocks having as few as 4 cells, but as many as 4, 8, 12, 16 or more battery cells all, or a portion of which, are connected in parallel by an interconnect board. Further, it is also to be understood that the battery module system and the battery system of the invention can include as few as a single tray supporting only a single battery block, but as many as 2, 3, 4, 5, 6, 7, 8 or more battery blocks.

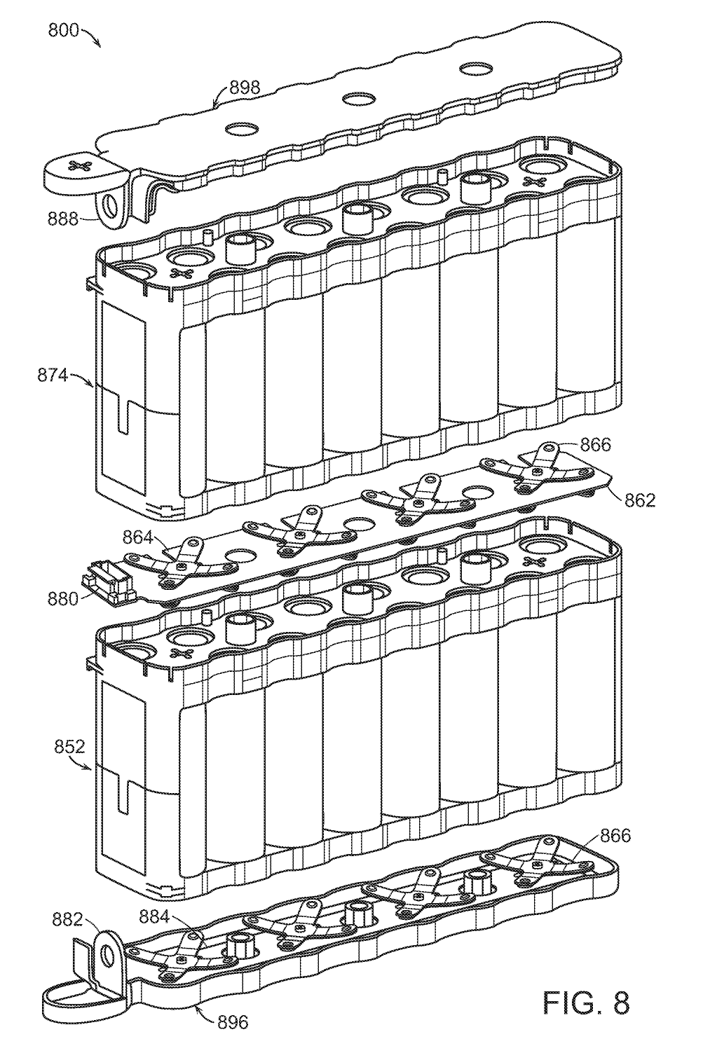

FIG. 8 shows an exploded view of a battery module system 800 in a further embodiment of the invention. Battery module system 800 includes first battery block 852, second battery block 874, interconnect board 862, first end cap 896 and second end cap 898, which are, for example, the same or modified versions of corresponding components shown in FIG. 7. First and second end caps 896, 898 each include a plurality of battery cell connectors 866, such as battery cell connectors 100, 300, 410 described above with reference to FIGS. 1A-C, 3A-C, 4A-C and 5. The battery cell connectors of end caps 896, 898 may be mounted to a single side of a metal layer 884 (e.g., a bus bar) for electrical communication with a respective negative terminal 882 and positive terminal 888. Metal layer may be made of any conductive material such as aluminum, copper, brass, or a copper alloy.

Interconnect board 862 includes circuit board 864 and battery cell connectors 866. Circuit board 864 has connected to it a plurality of battery cell connectors 166. Interconnect board 862 includes port 880 at at least one side of circuit board 864. Interconnect board 862 can be, or include some or all of the features of interconnect board 400 described above with reference to FIGS. 4A-C and 5. Further, each battery cell connector 866 can be a battery cell connector, as shown in FIGS. 1A-5. Interconnect board 862 is in mating relation with second battery block 874 at the first and second planes, whereby battery cells 878 of second battery block 874 can be connected in series to battery cells 854 of first battery block 852 through battery cell connectors 866 of interconnect board 862.

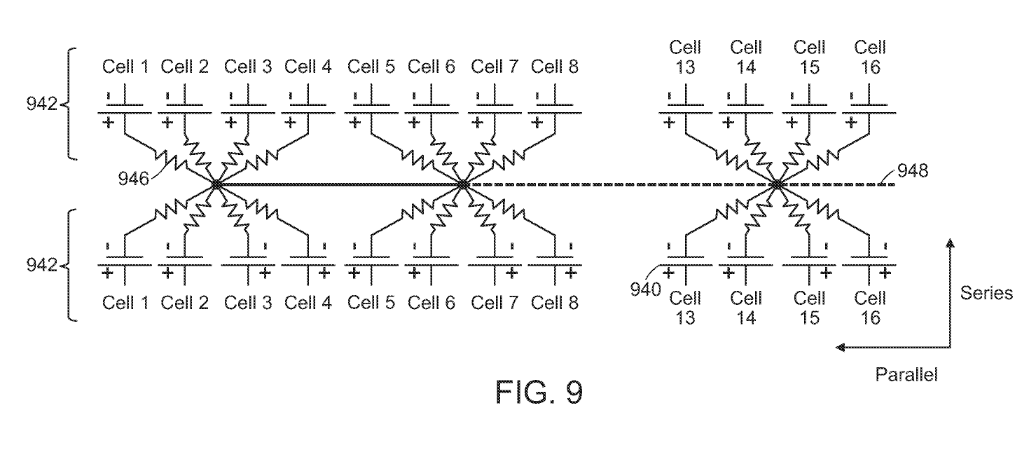

An electrical diagram showing the series and parallel connections of one embodiment of the battery module system, of the invention is shown in FIG. 9. In this embodiment, battery cells 940 of two battery blocks 942 are shown schematically connected in series by battery cell connectors 946, and the batteries of each battery block 942 are connected in parallel by interconnect board 948.

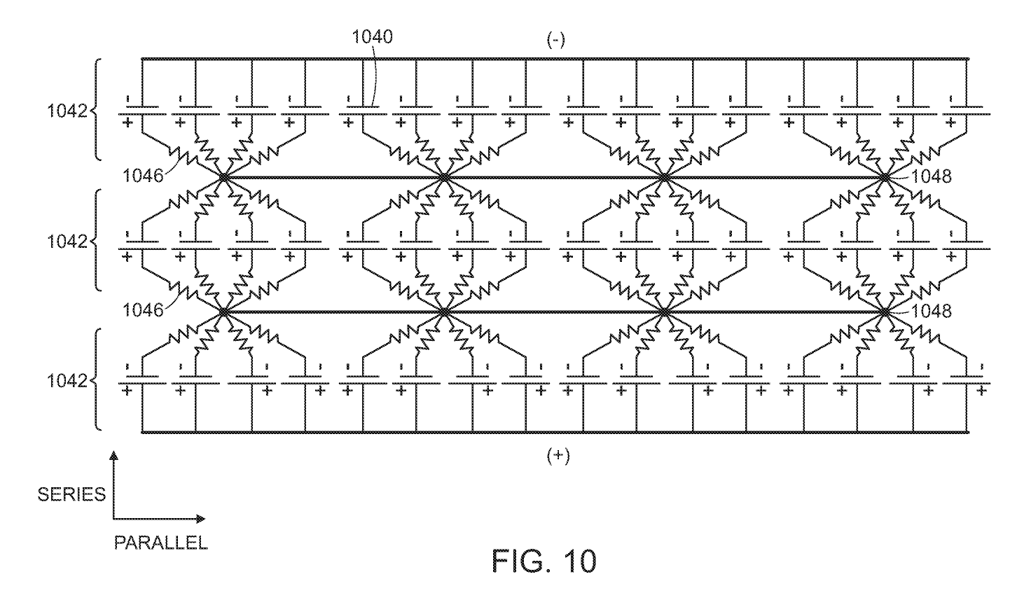

As can be seen in the electrical diagram of FIG. 10, three battery blocks 1042, each including eight battery cells 1040, are schematically shown connected in series via interconnect boards 1048. The battery cells 1040 of each battery block 1042 are connected in parallel to interconnect boards 1048 via battery cell connectors 1046. The circuits of FIGS. 9 and 10 may represent, in part, a circuit formed by the battery module systems 700, 800 of FIGS. 7 and 8.

FIG. 11 illustrates one embodiment of a battery cell connector 1100 of the invention that includes a spring. Battery cell connector may incorporate the features of battery cell connector 100 described above. In addition, battery cell connector 1100 includes spring 1180 fixed to base 1114 and extending along convex surface of arms 1112, whereby application of force to concave surface 1102 of arms 1112 causes spring 1100 to exhibit a spring constant. Although arms 1112 alone may exhibit a spring constant in response to such a force, spring 1180 can supplement the effective spring constant of arms 1112, thereby changing the spring constant of battery cell connector 1100.

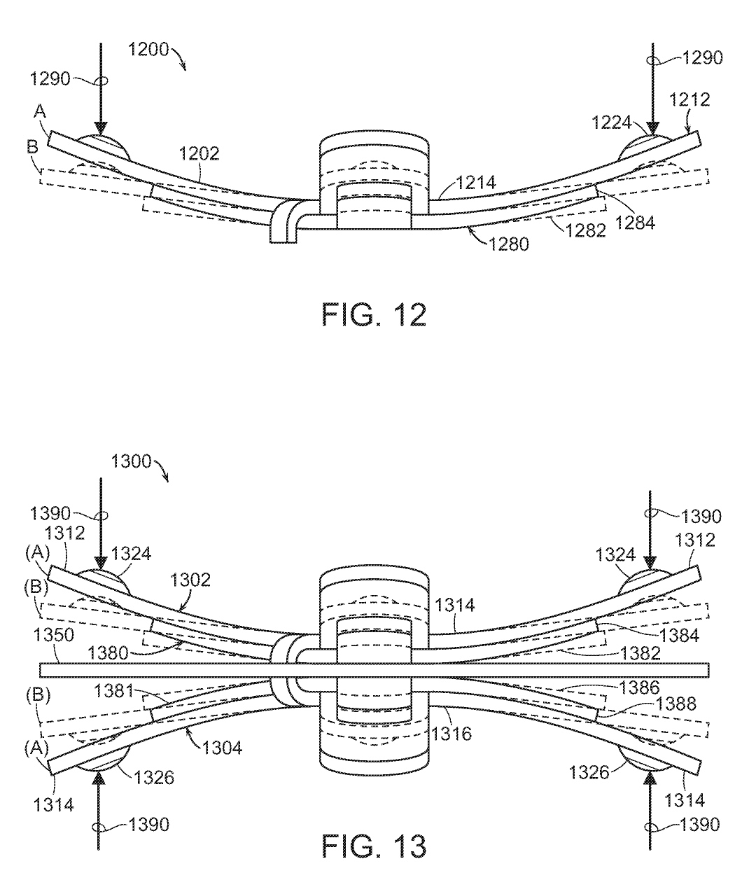

FIG. 12 is a side view of battery cell connector 1200 in an unloaded position (A), and in a loaded position (B). In the unloaded position (A) (i.e. no force is applied to protrusions 1224), spring 1280 is in contact with base 1214 and, optionally, but as shown in FIG. 12, also in contact with arms 1212 extending from base 1214. When force 1290 is applied to protrusions 1224, arms 1212 and spring 1280 move from position (A) to position (B), wherein arms 1282, which are in contact with, but not fixed to arms 1212, slide along arms 1212, as indicated by extension of end 1282 of spring 1280 along arm 1212 in the transition from position (A) to position (B) of arms 1212. Sliding of arms 1282 along arms 1212 allows the spring constant of spring 1280 to change the effective spring force of battery cell connector 1200.

FIG. 13 is a side view of one embodiment of an interconnect board 1300 of the invention that includes battery cell connectors 1302, 1304 connected to each other through circuit board 1350. Upon application of force 1390 on protrusions 1324, 1326 of arms 1312, 1314, respectively, battery cell connectors 1302, 1304 move from unloaded position (A) to loaded position (B). In transitioning from unloaded position (A) to loaded position B, arms 1382, 1386 of springs 1380, 1381, respectively, slide along arms 1312, 1314, respectively, as indicated by extension of ends 1384, 1388 of arms 1382, 1386 of spring 1380, 1381. This allows the spring constants of springs 1380, 1381 to change the effective spring force of battery cell connectors 1302, 1304, respectively.

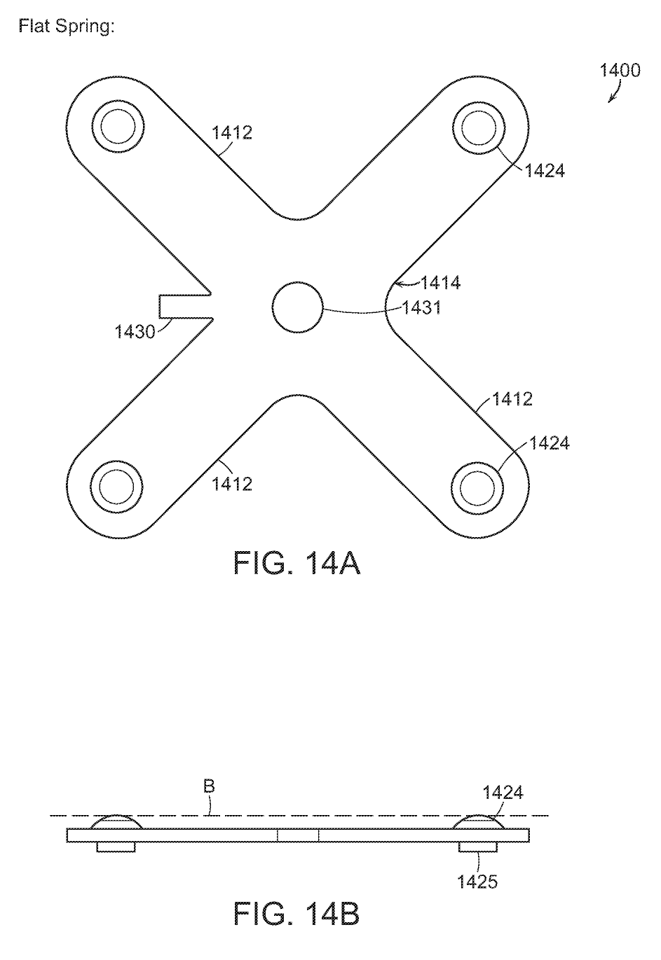

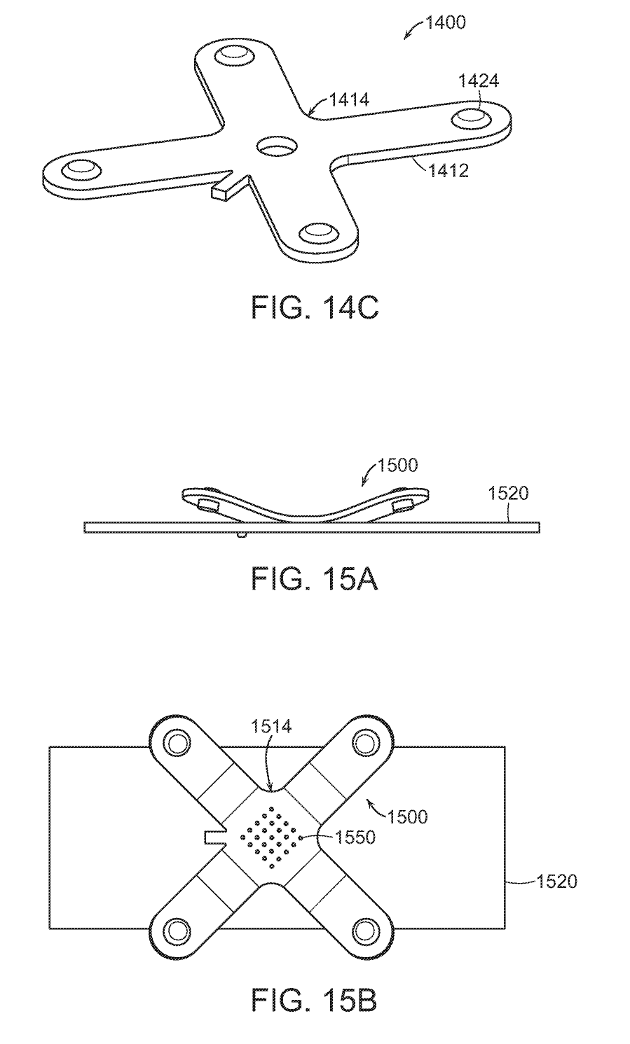

FIGS. 14A-C illustrate a further embodiment of battery cell connector 1400 of the invention. In contrast to battery cell connector 100 of FIGS. 1A-C, wherein arms 312 form concave and convex surfaces, arms 1412 of battery cell connector 1400 form a flat surface with base 1414. Aperture 1431 and 1430 can be employed to mount battery cell connector 100 to a circuit board or other device (not shown).

Arms 1412 include protrusions 1424 for contacting a terminal of a battery cell (not shown). In a specific embodiment, each protrusion 1424 is a contact pad at an end of arm 1412 distal to base portion 1414. The contact pad has a surface that is raised from arm 1412. Protrusions 1424 are fixed to arm 1412 or are integral to arm 1412. In one embodiment, as shown in FIGS. 14B and 14C, protrusions 1424 are fixed to arm 1412 by rivet 1425. In a further embodiment, protrusions 1424 are fixed to arm 112, absent rivet 125, by another suitable method, such as by soldering. Protrusions 1424 define virtual plane B.

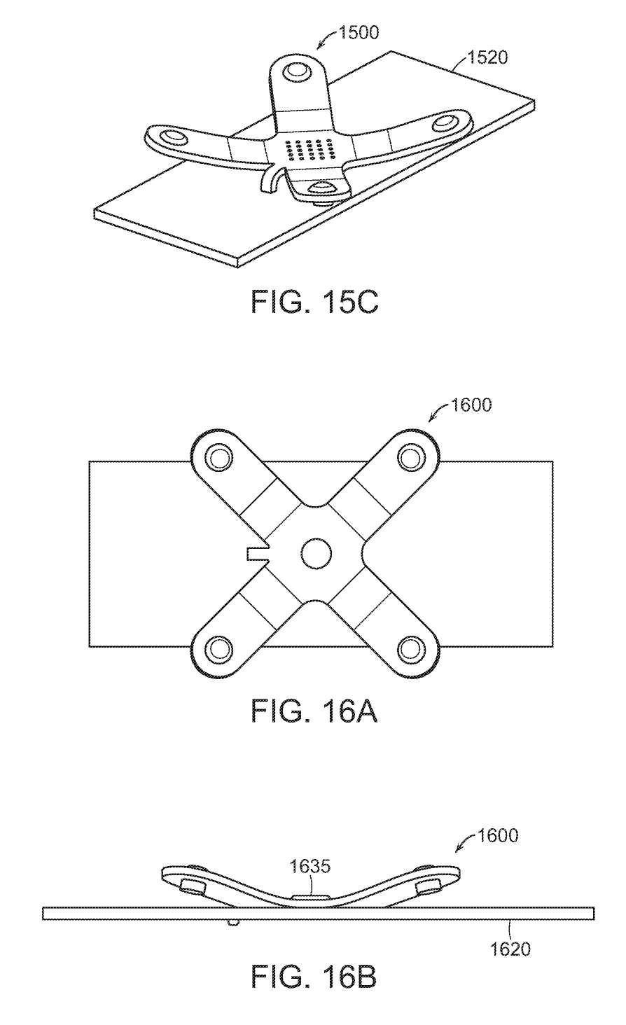

FIGS. 15A-C illustrate a further embodiment of battery cell connector 1500 of the invention. Battery cell connector 1500 may be configured similarly to the battery cell connector 100 of FIGS. 1A-C, with the exception that, rather than the base defining an aperture, base 1514 includes area 1550 that is fixed to circuit board 1520 via an ultrasonic weld.

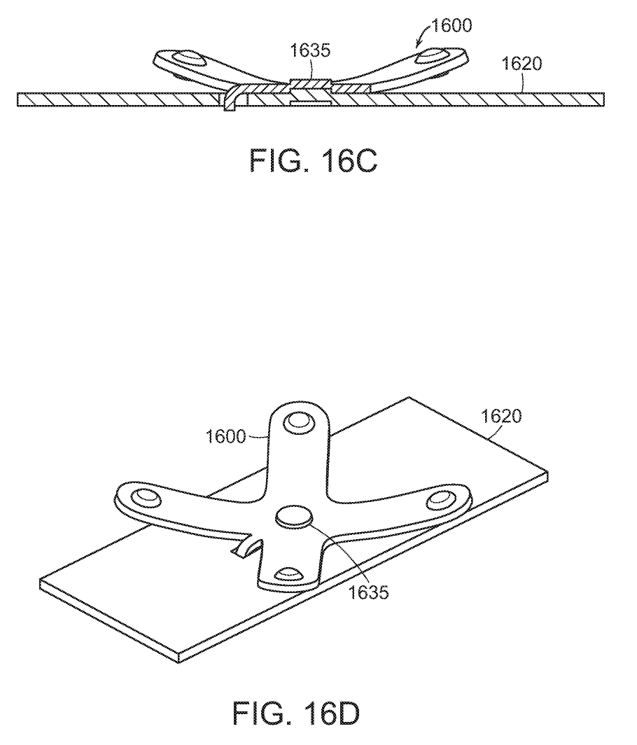

FIGS. 16A-D illustrate a further embodiment of battery cell connector 1600 of the invention. Battery cell connector 1600 may be configured similarly to the battery cell connector 100 of FIGS. 1A-C, and is fixed to circuit board 1620 via semi-pierce feature 1635.

While this invention has been particularly shown and described with references to example embodiments thereof, it will be understood by those skilled in the art that various changes in form and details may be made therein without departing from the scope of the invention encompassed by the appended claims.

The relevant teachings of all patents, patent applications and references cited herein are incorporated by reference in their entirety.

1. A battery cell connector, comprising:
a) a base; and
b) a plurality of arms extending radially from the base and defining distal ends, the base and the arms collectively defining a concave surface and a convex surface opposite the concave surface.

2. The battery cell connector of claim 1, wherein at least one of the arms includes contiguous segments.

3. The battery cell connector of claim 2, wherein at least one of the segments is essentially planar.

4. The battery cell connector of claim 3, wherein all of the arms include contiguous segments and all of the segments are essentially planar.

5. The battery cell connector of claim 1, wherein at least one of the arms defines a surface that is essentially planar.

6. The battery cell connector of claim 5, wherein all of the arms define a surface that is essentially planar.

7. The battery cell connector of claim 1, wherein at least one of the arms defines a surface that is arcuate.

8. The battery cell connector of claim 7, wherein all of the arms define a surface that is arcuate.

9. The battery cell connector of claim 1, further including a spring fixed to the base and extending along the convex surface of the arms, whereby application of force to the concave surface of the arms causes the spring to exhibit a spring constant.

10. The battery cell connector of claim 1, wherein the base and arms are formed of a single, continuous electrically-conductive material.

11. The battery cell connector of claim 1, wherein the base and arms have substantially uniform cross-sectional areas.

12. The battery cell connector of claim 1, wherein at least one of the arms includes a fusible link.

13. The battery cell connector of claim 12, wherein the fusible link has a cross-sectional area less than a cross-sectional area of the remainder of the arm.

14. The battery cell connector of claim 1, wherein at least one of the arms includes a protrusion at the distal end of the arm on the concave side.

15. The battery cell connector of claim 1, further including a tab extending from the base.

16. The battery cell connector of claim 1, where in the base defines an aperture.

17. The battery cell connector of claim 16, further including a rivet extending through the aperture and connected to another battery cell connector located on an opposite side of a printed circuit board (PCB).

18. The battery cell connector of claim 1, wherein a plurality of the arms extends radially from the base in a direction opposite that of another of the arms.

19. The battery cell connector of claim 1, wherein a plurality of the arms extends radially from the base in a direction having an angle of about 90 degrees with respect to another of the arms.

20. The battery cell connector of claim 1, wherein the arms and base include at least one of copper and aluminum.

21. The battery cell connector of claim 1, wherein the spring includes steel.

22. The battery cell connector of claim 1, wherein each of the arms includes a contact pad at a distal end of the arm on the concave side, and wherein the contact pads lie in a virtual plane.

23. The battery cell connector of claim 22, wherein the contact pad includes a nickel-silver alloy or mixture.

24. The battery cell connector of claim 1, wherein the base is fixed to a printed circuit board (PCB) via an ultra-sonic weld.

25. The battery cell connector of claim 1, wherein the base is a first base and the plurality of arms is a first plurality of arms, and further comprising:
a) a second base;
b) a second plurality of arms extending radially from the base and defining distal ends, the second base and the second arms collectively defining a concave surface and a convex surface opposite the concave surface; and
c) an electrically-conductive link between the first base and the second base.

26. The battery cell connector of claim 25, wherein the first and second bases are fixed to opposite surfaces of a circuit board, and the link includes an electrically-conductive channel connecting the first and second bases.

27. The battery cell connector of claim 26, wherein the arms each include a protrusion at or proximate to the distal end of the arm on the concave side, and wherein the protrusions lie in a plane.

28. An interconnect board for connecting a plurality of battery cells, comprising:
a) a circuit board including at least one electrically-conductive channel;
b) a plurality of battery cell connectors at the circuit board, at least a portion of which are in electrical communication with each other through the electrically conductive channel, wherein at least one of the battery cell connectors includes,
i) a base, and
ii) a plurality of arms extending radially from the base and defining distal ends, the base and the arms collectively defining a concave surface and a convex surface, opposite the concave surface; and
c) an electrically-conductive link between the bases of each pair of the battery cell connectors across the circuit board, the convex surface of each battery cell connector facing the circuit board.

29-42. (canceled)

43. A battery module system, comprising:
a) a first tray for supporting a first plurality of battery cells of a first battery block, wherein the first plurality of battery cells is assembled within the first tray, and wherein first terminals of the first plurality of battery cells are aligned in a first plane at a first end of the first battery block and second terminals of each of the first plurality of battery cells are aligned in a second plane at a second end of the first battery block;
b) a second tray for supporting a second plurality of battery cells of a second battery block, wherein the second plurality of battery cells is assembled within the second tray, and wherein first terminals of the second plurality of battery cells are aligned in a first plane at a first end of the second battery block and second terminals of each of the plurality of battery cells are aligned in a second plane at a second end of the second battery block; and
c) an interconnect board in mating relationship with the first tray and the second tray, the interconnect board including a circuit board and a plurality of battery cell connectors, at least a portion of which are in electrical communication with each other through the interconnect board, wherein at least one of the battery cell connectors includes,
i) a base, and
ii) a plurality of arms extending radially from the base and defining distal ends, the base and the arms collectively defining a concave surface and a convex surface opposite the concave surface, and
iii) an electrically-conductive link between the bases of each of pairs of the battery connectors, and extending through the circuit board, and whereby the first and second battery cells of the first and second battery blocks, respectively, are in contact with at least a portion of the arms of the pairs of the battery cell connectors, the first and second battery cell blocks thereby being in series electrical communication with each other.

44-59. (canceled)

60. A battery cell connector, comprising:
a) a first base;
b) a first plurality of arms extending radially from the base and defining distal ends, the first base and the first arms collectively defining a first concave surface and a convex surface opposite the first concave surface;
c) a second base;
d) a second plurality of arms extending radially from the base and defining distal ends, the second base and the second arms collectively defining a second concave surface and a second convex surface opposite the second concave surface; and
e) an electrically conductive link between the first base and the second base.

61-69. (canceled)

70. A battery cell connector, comprising:
a) a base;
b) a plurality of arms extending radially from the base and defining distal ends, the base and the arms collectively defining an essentially flat surface; and
c) a plurality of protrusions each located at a respective distal end of one of the plurality of arms.

71-76. (canceled)
